(19) United States
(12) Patent Application Publication
(10) Pub. No.: US 2004/0132460 A1
(43) Pub. Date: Jul. 8, 2004

(54) Method for preventing overload in base station and base station system thereof

(75) Inventor: Moon Han Lee, Seoul (KR)

Correspondence Address: JONATHAN Y. KANG, ESQ., LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/739,724

(22) Filed: Dec. 17, 2003

(30) Foreign Application Priority Data
Dec. 20, 2002 (KR) 2002-081722

(51) Int. Cl. H04Q 7/20

(52) U.S. Cl. 455/453

(57) ABSTRACT

A base station in a mobile communications system is provided. The base station comprises a reception processing unit demodulating a reception signal; an interference level measuring unit measuring an interference level (ROT) of the reception signal by uniform time interval; and an interference level processing unit comparing a previously measured first interference level with a newly measured second interference level to selectively output the second interference level to a second processor.

### CROSS REFERENCE TO RELATED APPLICATIONS

This application claims the benefit of the Korean Application No. P2002-081722 filed on Dec. 20, 2002, the content of which is hereby incorporated by reference in its entirety.

### BACKGROUND OF THE INVENTION

1. Field of the Invention

The present invention relates to a method for preventing overload in a base station of mobile communication system and more particularly, to a method to reduce network overload generated from the base station in the process of measuring and transferring interference level in a mobile communication system supporting high-speed data services.

2. Discussion of the Related Art

1xEV-DO is a high-speed data service developed by Qualcomm of U.S.A. in the late 1990's. The 1xEV-DO (1x evolution-data only) system adopts an intrinsic resource allocation method fitting the respective link.

A base station consecutively transmits pilot signals with constant power in case of the forward link. The terminals in a cell measure the strength of the pilot signal to estimate channel status of the forward link. Once such an estimated channel status is reported to the base station, a scheduler of the base station determines whether to allocate a forward link resource to a specific terminal according to the forward channel status reported by each of the terminals with time-share for each slot.

The scheduler basically operates to allocate the maximum number of resources to the terminal with the best channel status. This maximizes total data throughput of the forward link for each cell.

Since the base station receives reverse pilot signals from terminals scattered in the cell, it is unable to grasp the reverse link characteristics related to the respective mobile terminals from the strength of the reception signal received from each terminal through an antenna of the base station, unlike the case of the forward link.

Instead, to measure the strength of the entire reception signals received through the reception antenna, the base station indirectly controls a load amount of the reverse link in a manner that the reverse link resource allocation of the same level is directed to the entire terminals based on the measured strength.

Each terminal in the cell receives reverse link load amount (data rate) direction bit [reverse activity bit (hereinafter abbreviated RAB)] as data rate increase/decrease information each slot from the base station, and determines the data rate, by which the terminal will transmit the data for the next frame, using probability based on the value of the RAB.

For example, if the RAB received from the base station directs that the data rate should be lowered, each terminal determines with probability whether to lower or maintain the data rate of the next frame according to the current reverse link data rate. If the base station directs to increase the data rate via RAB, the data rate of the next frame is determined in the same manner.

Therefore, since the entire terminal in the cell adjust the data rate of the reverse link according to the RAB set by the base station, the RAB setup becomes a means for adjusting the load amount of the reverse link.

In one embodiment, the base station sets the RAB based on the following algorithm. First, total reception power (Rx Power_Total) received via an antenna of a reception end of the base station and thermal noise power (Rx Power_Thermal) of the base station system are measured. Thermal noise power vs. reception signal power [rise over thermal (hereinafter abbreviated ROT)] corresponding to the difference of the two values (i.e. interference level) is measured. And, the ROT is compared to a reference value (ROT_Thresh), which was set up previously, to determine the RAB.

In this case, the reference value (ROT_Thresh) is commonly set up into a level somewhat lower than a maximum interference level (ROT) acceptable by the base station and the measured ROT value is simply compared to the reference value (ROT_Thresh) each slot to determine the RAB.

FIG. 1 illustrates a block diagram of a base station (BS) system for generating increase/decrease information of reverse link load amount in a base station of a mobile communication system and for transmitting it to each mobile station.

Referring to FIG. 1, a base station 10 according to a related art, which generates reverse activity bit (RAB) in a base station and transmits it to a mobile station (not shown in the drawing). In one embodiment, the base station 10 comprises a reception processing unit 11 for receiving a transmission signal from a mobile station (MS) through a reception antenna. The reception processing unit 11 demodulates the received signal. An interference level measuring unit 12 for measuring an interference level (ROT) for a signal transferred from the reception processing unit 11 is also included.

A comparison unit 13 for comparing a value measured by the interference level measuring unit 12 to a predetermined reference value (ROT_Thresh) is included in one embodiment. A RAB & transport channel determining unit 14 for determining a location of each mobile station according to a RAB location in a channel slot by determining a RAB according to a result of the comparison procedure are also included. A transmission processing unit 15 for modulating a transmission signal carrying the RAB outputted from the RAB & transport channel determining unit 14 can be also included.

In a related art RAB transmitting method having the above-explained configuration, the interference level measuring unit 12 measures the interference level (ROT) of the signal transferred from the reception processing unit 11 by uniform time interval, and transfers it to the comparison unit 13. The comparison unit 13 then measures a load of a reverse link by comparing the interference level (ROT) with the predetermined reference value (ROT_Thresh) to transfer to the RAB & transport channel determining unit 14.

The RAB & transport channel determining unit 14 determines the RAB from the mobile station according to the comparison result of the comparison unit 13 and then determines a location of each mobile station according to the RAB in the channel slot to transmit to the transmission processing unit 15. The transmission processing unit 15 then modulates the transmission signal, which carries transmission data rate information and the data rate increase/decrease information (RAB) outputted from the RAB & transport channel determining unit 14, and transmits the modulated signal to the mobile station.

In this case, the RAB setup in the mobile communication system should be determined by slot unit. Specifically, since a RAB setup period determines a data rate by which the terminal will transmit data in a next frame over reverse link, it is preferable to be smaller than a frame length of a minimum reverse link. Hence, the interference measuring unit 12 measures the interference level (ROT) by tick unit which is a minimum unit provided by a processor and transfers the value to the comparison unit 13.

However, the interference level ROT measuring unit and the comparison unit are built in separate processors, respectively. Since massive amount of data should be exchanged between the separate processors for unit time for the RAB setup, the related art brings about overload in the base station.

### SUMMARY OF THE INVENTION

In accordance with one embodiment of the invention, a method for preventing overload in base station in a mobile communication system is provided. The method comprises comparing interference levels measured in predetermined time intervals; and selectively outputting a first interference level based on results of the comparing. The interference levels are measured in a reverse link.

In one embodiment, the comparing step comprises comparing a previous interference level with a new interference level. The first interference level is a newly measured interference level. The first interference level is provided to a second processor, when a difference between the new and previous interference levels is greater than a specific value.

When the new interference level is provided to the processor, the previous interference level is replaced with the new interference level. A first processor performs the comparing and outputting steps, in one embodiment.

The second processor is a channel card processor for controlling radio access according to mobile station and radio interface specifications. In some embodiments, the mobile communication system is a 1xEV-DO system or a 1xEV-DV system.

In accordance with another embodiment, a method for preventing overload in base station, in a mobile communication system comprises measuring a first interference level of a reverse link; measuring a second interference level by uniform time interval; comparing the first and second interference levels using a first processor; and outputting the second interference level to a second processor, when difference between the second and first interference levels is greater than a threshold.

The first interference level is replaced by the first interference level. In one embodiment, the measuring steps are performed in the first processor. The second processor is a channel card processor for controlling radio access according to mobile station and radio interface specifications.

In yet another embodiment, a base station in a mobile communications system is provided. The base station comprise a reception processing unit demodulating a reception signal; an interference level measuring unit measuring an interference level (ROT) of the reception signal by uniform time interval; and an interference level processing unit comparing a previously measured first interference level with a newly measured second interference level to selectively output the second interference level to a second processor.

The base station of claim 15, wherein the interference level processing unit outputs the second interference level to the second processor when a difference between the first and second interference levels is greater than a threshold.

The base station of claim 15, further comprising a memory unit for storing the first and second interference levels. The interference level measuring unit and the interference level processing unit are implemented on a first processor. The second processor is a channel card processor controlling radio access according to mobile station and radio interface specifications.

The channel card comprises a comparison unit for comparing the second interference level outputted from the interference level processing unit to a previously set reference value (ROT_Thresh); and a RAB generating unit generating a reverse link direction bit (RAB) according to a comparison result of the comparison unit.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a block diagram of a base station (BS) system required for generating increase/decrease information of reverse link load amount in a base station of a mobile communication system and for transmitting it to each mobile station, in one or more embodiments.

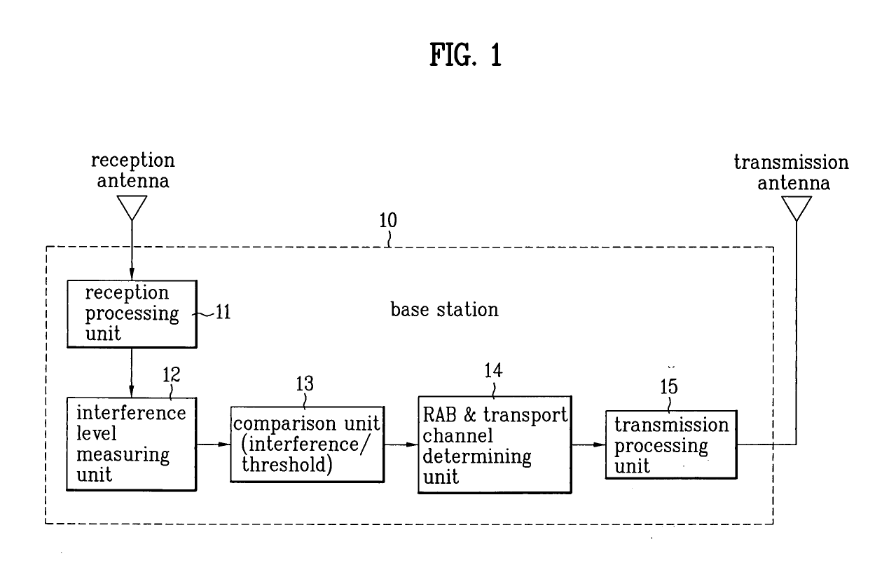

FIG. 2 illustrates a block diagram of a base station system according to one preferred embodiment of the present invention.

FIG. 3 illustrates a flowchart of a method for measuring interference level in base station according to one embodiment of the present invention.

FIG. 4 illustrates a flowchart of a method for transmitting interference level (ROT) to a channel card according to one embodiment of the present invention.

Features, elements, and aspects of the invention that are referenced by the same numerals in different figures represent the same, equivalent, or similar features, elements, or aspects in accordance with one or more embodiments of the system.

### DETAILED DESCRIPTION OF THE INVENTION

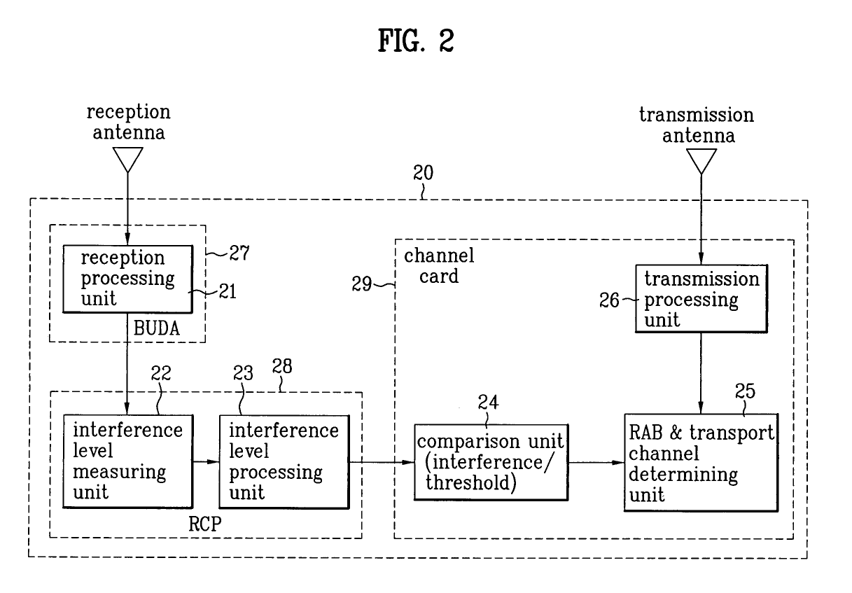

Referring to FIG. 2, a base station 20, according to an embodiment of the present invention, comprises a base station sector conversion & up/down converter assembly (BUDA) 27 converting digital and analog signals. A channel card 29 for radio access according to mobile station and radio interface specifications, and a radio & channel processor (RCP) 28 for controlling the channel card 29 and controlling the BUDA 27 and other RF equipments may be included. The BUDA 27 comprises a reception processing unit 21 for demodulating a signal received via a reception antenna.

The RCP 28 comprises an interference level measuring unit 22 measuring interference level for a signal transferred from the reception processing unit 21 of the BUDA 27, an interference level processing unit 23 comparing the measured interference level to an interference level previously transferred to the channel card 29 to transmit a corresponding interference level (ROT) to the channel card 29 if a difference resulted from the comparison is equal to or greater than a predetermined value set previously, for example. A memory unit (not shown in the drawing) for storing the previous interference level and a new interference level, may be also included.

In one embodiment, the channel card 29 comprises a comparison unit 24 for comparing the interference level transmitted from the interference level processing unit 23 to a predetermined reference value (ROT_Thresh), a RAB & transport channel determining unit 25 determining a location of each mobile station according to a RAB location in a channel slot by determining reverse link load amount direction bit (RAB) according to result of the comparison. A transmission processing unit 26 modulating a transmission signal carrying the reverse link load amount direction bit (RAB) outputted from the RAB & transport channel determining unit 25 is included in a preferred embodiment.

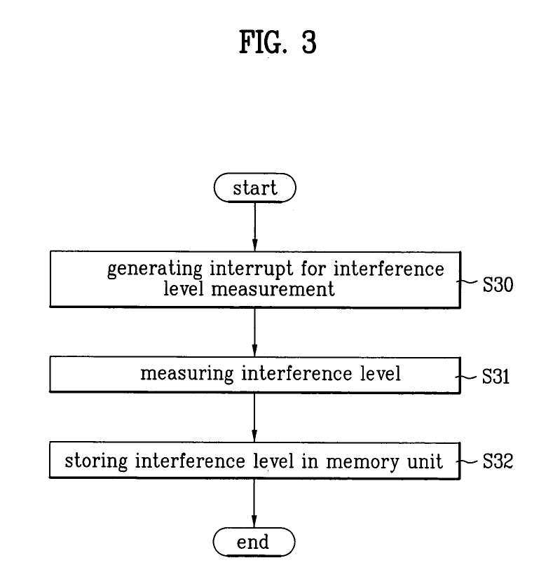

Referring to FIG. 3, the BUDA 27 converts a received analog signal to a digital signal and transmits it to the interference level measuring unit 22. The RCP 28 generates an interrupt for interference level (ROT) measurement (S30). The interference level measuring unit 22 of the RCP 28 accordingly measures the interference level (ROT) of the signal transferred from the reception signal processing unit 21 of the BUDA 27 (S31)

The interference level (ROT) can be measured by measuring total reception power (Rx Power_Total) received via an antenna of the reception end of the base station and thermal noise power (Rx Power_Thermal) of the base station system itself and by calculating a difference between the two values (if unit is dB)). The measured interference level (ROT) is stored in the memory unit in some embodiments.

A measured new interference level (ROT_{new}) is, for example, stored in the memory unit (S32). The new interference level (ROT_{new}) and a previous interference level (ROT_{old}) having been transferred to the channel card 29 are at least stored in the memory unit. It is a matter of course that the memory unit for storing the previous and new interference levels (ROT_{old} and ROT_{new}) can be built separately for the convenience of the system.

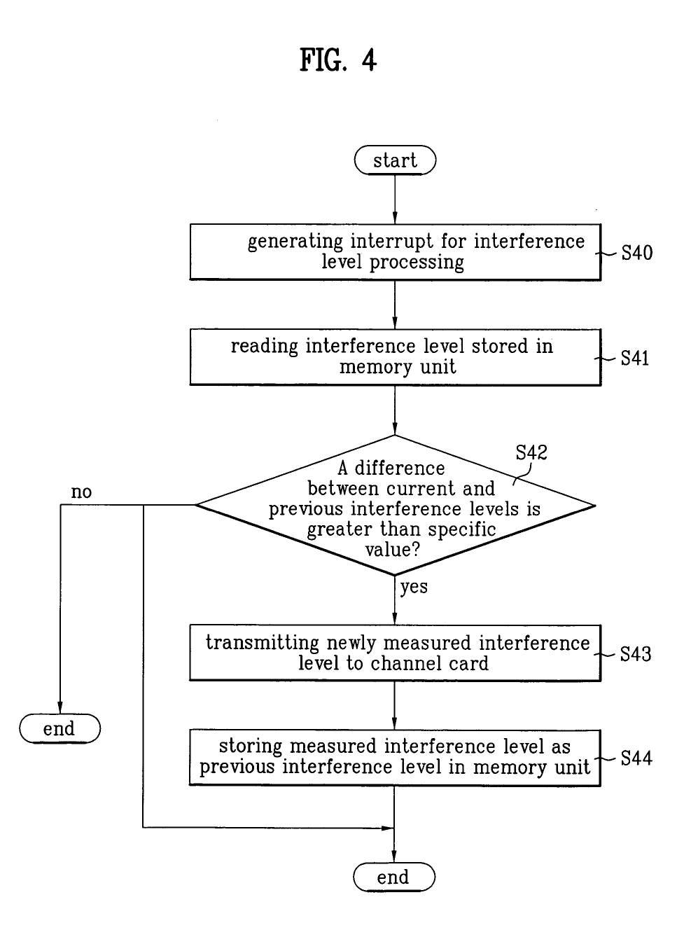

Referring to FIG. 4, the new interference level (ROT_{new}) measured in the interference level measuring unit 22 is stored in the memory unit in one embodiment. The RCP 28 generates an interrupt to the interference level processing unit 23 (S40). The interference level processing unit 23 accordingly reads the new and previous interference levels (ROT_{new} and ROT_{old}) stored in the memory unit (S41) and then judges whether the difference between the new and previous interference levels (ROT_{new} and ROT_{old}) is greater than (or equal to) a specific value set previously (S42).

If the difference between the new and previous interference levels (ROT_{new} and ROT_{old})is not greater than the specific value, the measured new interference level (ROT_{new}) is not transferred to the channel card 29. There is no data exchange between processors of the RCP 28 and channel card 29 so that data is not transmitted, whereby there is no load due to the transmission of interference level (ROT) in the base station system.

If the difference between the new and previous interference levels (ROT_{new} and ROT_{old})is greater than or equal to the specific value, the RCP 28 transmits the measured new interference level (ROT_{new}) to the channel card 29 (S43) and updates the memory unit to store the measured interference level (ROT_{new}) into a new previous interference level (ROT_{old′}) (S44), for example.

The comparison unit 24 of the channel card 29 compares the interference level (ROT) transferred from the interference level processing unit 23 to a predetermined reference value (ROT_Thresh) and transmits the comparison result to the RAB & transport channel determining unit 25.

By determining the reverse link load amount direction bit RAB according to the comparison result, the RAB & transport channel determining unit 25 determines the location of each mobile station according to the RAB in the channel slot and then transfer it to the transmission processing unit 26. The transmission processing unit 26 modulates the transmission signal carrying the RAB outputted from the EAB & transport channel determining unit 25 and then transmits it to the mobile station via transmission antenna.

The above-description of the embodiment is focused on the RAB setup method in the base station of 1xEV-DO system providing high-speed data services. Yet, the present invention can be applied to 1xEV-DV system and the like providing high-speed packet data and voice services as well as other purposes including the RAB setup.

What is claimed is:

1. A method for preventing overload in base station, in a mobile communication system, the method comprising:
comparing interference levels measured in predetermined time intervals; and
selectively outputting a first interference level based on results of the comparing.

2. The method of claim 1, wherein the interference levels are measured in a reverse link.

3. The method of claim 2, wherein comparing step comprises comparing a previous interference level with a new interference level.

4. The method of claim 1, wherein the first interference level is a newly measured interference level.

5. The method of claim 3, wherein the first interference level is provided to a second processor, when a difference between the new and previous interference levels is greater than a specific value.

6. The method of claim 5, wherein when the new interference level is provided to the processor, the previous interference level is replaced with the new interference level.

7. The method of claim 1, wherein a first processor performs the comparing and outputting steps.

8. The method of claim 5, wherein the second processor is a channel card processor for controlling radio access according to mobile station and radio interface specifications.

9. The method of claim 1, wherein the mobile communication system is a 1xEV-DO system.

10. The method of claim 1, wherein the mobile communication system is a 1xEV-DV system.

11. A method for preventing overload in base station, in a mobile communication system, the method comprising:
measuring a first interference level of a reverse link;
measuring a second interference level by uniform time interval;
comparing the first and second interference levels using a first processor; and
outputting the second interference level to a second processor, when difference between the second and first interference levels is greater than a threshold.

12. The method of claim 11, wherein the first interference level is replaced by the first interference level.

13. The method of claim 11, wherein the measuring steps are performed in the first processor.

14. The method of claim 11, wherein the second processor is a channel card processor for controlling radio access according to mobile station and radio interface specifications.

15. A base station in a mobile communications system, the base station comprising:
a reception processing unit demodulating a reception signal;
an interference level measuring unit measuring an interference level (ROT) of the reception signal by uniform time interval; and
an interference level processing unit comparing a previously measured first interference level with a newly measured second interference level to selectively output the second interference level to a second processor.

16. The base station of claim 15, wherein the interference level processing unit outputs the second interference level to the second processor when a difference between the first and second interference levels is greater than a threshold.

17. The base station of claim 15, further comprising a memory unit for storing the first and second interference levels.

18. The base station of claim 15, wherein the interference level measuring unit and the interference level processing unit are implemented on a first processor.

19. The base station of claim 15, wherein the second processor is a channel card processor controlling radio access according to mobile station and radio interface specifications.

20. The base station of claim 19, wherein the channel card comprises:
a comparison unit for comparing the second interference level outputted from the interference level processing unit to a previously set reference value (ROT_Thresh); and
a RAB generating unit generating a reverse link direction bit (RAB) according to a comparison result of the comparison unit.

21. The base station of one of claim 15, wherein the mobile communication system is a 1xEV-DO system.

22. The base station of one of claim 15, wherein the mobile communication system is a 1xEV-DV system.
